(19) United States
(12) Patent Application Publication
(10) Pub. No.: US 2022/0242741 A1
(43) Pub. Date: Aug. 4, 2022

(54) IMITATION CORN KERNALS AND MANUFACTURING METHODS

(71) Applicant: The GSI Group LLC, Assumption, IL (US)

(72) Inventors: Andrew Jordan, Assumption, IL (US); Chad DeMars, Omaha, NE (US); Jeffrey Alan Doneghue, Assumption, IL (US)

(21) Appl. No.: 17/649,403

(22) Filed: Jan. 31, 2022

Related U.S. Application Data
(60) Provisional application No. 63/143,628, filed on Jan. 29, 2021.

(51) Int. Cl. C01F 7/16; G01M 99/00; C08L 101/00

(52) U.S. Cl. CPC C01F 7/16; G01M 99/005; C08L 2207/04; C01P 2006/16; C08L 101/00

(57) ABSTRACT

An imitation corn kernel is used to emulate a real corn kernel for use in research and testing of a grain drying system. The imitation corn kernel includes a core material that retains moisture and a shell material that repels moisture.

### BACKGROUND OF THE INVENTION

### Field of Invention

This disclosure relates to research and testing of grain dryers, and more particularly to an imitation corn kernel for use in research and testing of grain dryers.

### Description of Related Art

Grains such as corn, wheat, soybean, and other agricultural products often need to be dried after harvesting to achieve a final moisture content adequate to inhibit microbial growth and preserve the value of the product during storage. FIG. 1 shows a prior art grain drying tower that allow farmers to start harvesting earlier at higher moisture levels and to dry the harvest to more optimal moisture content, increasing yields and improving profits. This allows the farmer to minimize weather risks, reduce dry matter loses, and reduce head shatter loss. Drying involves the reduction of moisture from about 17-30% w/w to values between 8 and 15% w/w, depending on the harvested product.

Grain dryer manufactures are constantly researching and developing ways to improve current products or create new dryer products and drying methods that are able to increase the efficiency and effectiveness of the drying process. Traditionally, as new products are designed and tested, the engineering and test staff is forced to wait until the annual fall harvest in order to test real grain under real conditions. Thus, engineers tasked with developing these new products and/or improving current products struggle with meeting the appropriate timeline set by local crop harvest constraints. Come harvest season, these engineers often frantically complete designs in order to test in real-life applications in the local area. Not only does this put stress on the engineering department, but it also strains the supporting groups that assist in the design, manufacture, install, and testing of new products. The inability to test current product improvements and new product developments year round due to the seasonality of the grain crop and availability of off-season grain.

Having an imitation corn kernel that behaves similarly to actual corn kernels but would allow year-round testing opportunities would alleviate these strains.

### BRIEF SUMMARY OF THE INVENTION

In one aspect, the invention is directed to an imitation corn kernel is used to emulate a real corn kernel for use in research and testing of a grain drying system. The imitation corn kernel includes a core material that retains moisture and a shell material that repels moisture.

This summary is provided to introduce concepts in simplified form that are further described below in the Description of Preferred Embodiments. This summary is not intended to identify key features or essential features of the disclosed or claimed subject matter and is not intended to describe each disclosed embodiment or every implementation of the disclosed or claimed subject matter. Specifically, features disclosed herein with respect to one embodiment may be equally applicable to another. Further, this summary is not intended to be used as an aid in determining the scope of the claimed subject matter. Many other novel advantages, features, and relationships will become apparent as this description proceeds. The figures and the description that follow more particularly exemplify illustrative embodiments.

### BRIEF DESCRIPTION OF THE DRAWINGS

The disclosed subject matter will be further explained with reference to the attached figures, wherein like structure or system elements are referred to by like reference numerals throughout the several views.

FIG. 1 is a perspective view of prior art grain dryer;

FIG. 2 is a perspective view of an imitation corn kernel for use with testing of a grain dryer; and

FIG. 3 is a perspective view of another embodiment of an imitation corn kernel for use with testing of a grain dryer.

Corresponding reference characters indicate corresponding parts throughout the several views of the drawings.

### DESCRIPTION OF PREFERRED EMBODIMENTS

The following detailed description illustrates the invention by way of example and not by way of limitation. This description will clearly enable one skilled in the art to make and use the invention, and describes several embodiments, adaptations, variations, alternatives and uses of the invention, including what we presently believe is the best mode of carrying out the invention. Additionally, it is to be understood that the invention is not limited in its application to the details of construction and the arrangements of components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

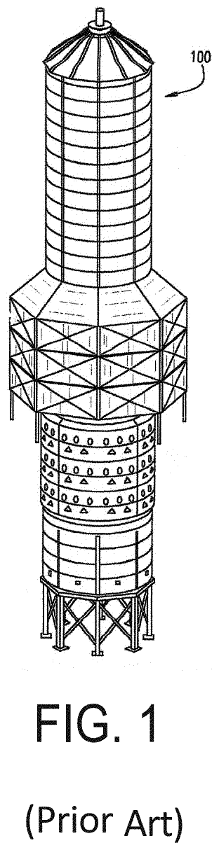

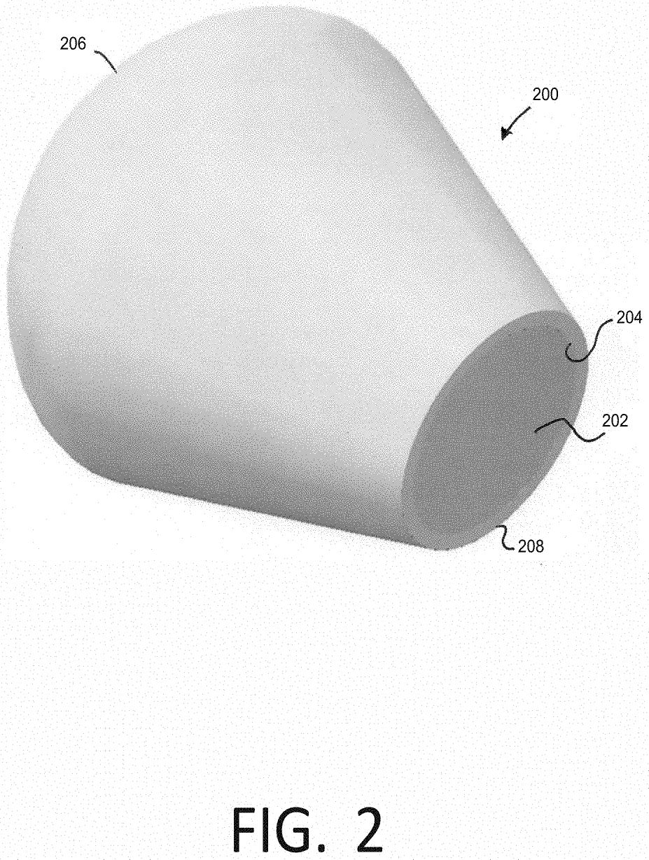

Referring initially to FIG. 2 of the drawings, an imitation corn kernel 200 used to emulate a real corn kernel for use in research and testing of a drying system 100 such as the one shown in FIG. 1 so that testing of the drying system may occur even outside of the harvesting season when real corn kernels are more readily available. As one skilled in the art would understand, real corn kernels have a complex physical structure. In order to gain the most benefit from using the imitation corn kernel 200 when testing, it is desirable that the imitation corn kernel replicate key physical attributes of a real corn kernel.

In a real corn kernel, an outer hull is comprised of several layers of inert materials that often reach 30% cellulose content. This high cellulose content is the driving force that produces the hardened outer shell of the kernel. The shell, or hull, covers the entire seed, excluding the tip cap, and acts as a barrier to disease, fungus, chemicals, and moisture. Internally, a germ maintains high levels of oils and proteins which provide the ‘life’ to the seed. The germ also contributes to the majority of the moisture retaining abilities of corn kernels, pulling moisture and nutrients into the seed through the tip cap. The remaining internal structure of the corn kernel is made up of starchy endosperm, containing some, although miniscule, amounts of proteins. It is known that a real corn kernel allows transfer of moisture only through the tip cap of the corn kernel, offering little to no moisture transfer through the outer hull of the kernel. The germ and the soft endosperm contain the highest moisture content of the kernel, while the region near the tip cap offers the lowest moisture retention. Thus, moisture is more easily transferred from the tip cap region, while extra effort is required to remove moisture from the germ and endosperm.

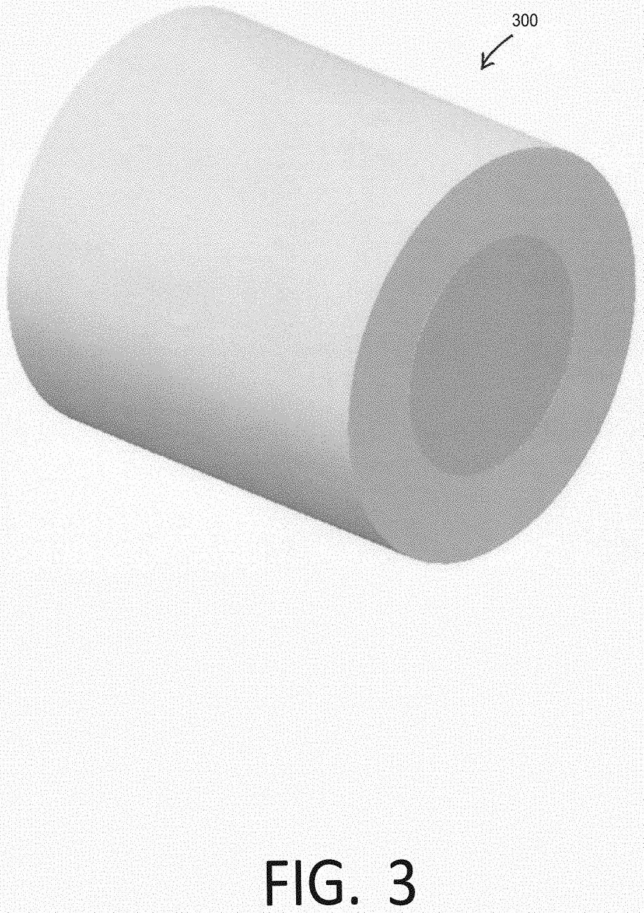

As seen in the embodiment of FIG. 2, the imitation corn kernel 200 comprises a core material 202, which is designed to retain moisture, and a shell material 204, which is designed to repel moisture. Desirably, the imitation corn kernel 200 allows for moisture retention in the core material 202 and drying/re-wetting capabilities so that the imitation corn kernel can be repeatedly reused. Accordingly, it is desired that outer shell 204 the imitation corn kernel 200 closely replicate the external structure of a real corn kernel in an effort to more nearly relate to the behavior of moisture in an actual corn kernel. In FIG. 2, the corn kernel 200 has a general frusta-conical shape with a larger base end 206 and a smaller tip end 208. In one embodiment, the outer shell 204 covers the entire base end 206. Alternately, FIG. 3 shows an embodiment with an imitation corn kernel 300 having generally cylindrical shape. In one embodiment, the shell material 204 of the corn kernel 200, 300 is made of a thermo plastic. In one embodiment, the core material 202 of the corn kernel 200, 300 is made of a silica-rich, large-pore zeolite such as Mordenite. Natural zeolites that occur in nature as a mineral or synthetic zeolites can be used.

In use, it is desirable that the imitation corn kernels 200 have a size comparable with real corn kernels so as to be handled with standard material handling equipment. Desirably, the imitation corn kernel 200 has a length in the range from 0.46-0.54 inches, a width to range from 0.27-0.35 inches, and a thickness to range from 0.14-0.18 inches. Desirably, the imitation corn kernels 200 have a mass of between about 1,200-1,450 kernels/pound. Desirably, the imitation corn kernels 200 have a density of about 50-60 pounds/bushel, which equates to about 41-49 pounds/ft3. If the imitation corn kernels were to be too dense, the kernel size would allow much greater compaction than seen in average bulk supplies of corn, resulting in a larger density and different characteristics when going through the drying process.

Due to the extreme amount of grain movement within and over the drying and handling systems 100, the imitation corn kernel 200 should closely reflect both the static and dynamic coefficients of friction of real corn kernels. It is believed that real corn kernels on galvanized sheet steel, with a moisture content (wet basis) of 13.9%, show a standard static coefficient of friction (μS) of 0.37 and a dynamic coefficient of friction (μD) of 0.38.

Porosity, which is defined as the volume of air or void space to the total volume, is affected by multiple physical characteristics of the particles being stored, including the particle size, the particle shape, the bulk moisture content, and the level of compaction of the mass. Likewise, the bulk porosity of the mass greatly affects the ability for airflow through the particles, ultimately affecting the attainable static pressure levels commonly referenced in conditioning processes. It is believed that a bulk store of shelled yellow dent corn with a wet basis moisture content of 15% has an average porosity of 40% and that shelled yellow dent corn at 25% moisture has an average porosity of 44% and that porosity generally increases with an increase in moisture content. Desirably, the imitation corn kernel 200 replicates these values as closely as possible when stored in bulk masses. Not only will proper porosity in the mass affect conditioning rates and static pressures, but it will also affect the airflow and static pressures that are observed in in-bin aeration, among other potential product testing opportunities.

In order to prepare grains for long term storage (and even immediate use to some degree), the grain will undergo a series of heating and cooling processes to maintain its integrity and withdraw moisture. Intense heat is applied to the grain rather rapidly during conditioning processes, and it typically followed by direct air cooling for storage. It is desirable that the imitation corn kernel 200 withstand the vast temperature swings seen in real grain applications.

The imitation corn kernels 200 may be made using one of any known manufacturing processes such as injection molding, co-extrusion, subtractive, additive manufacturing, or a combination of these or other common manufacturing methods. In one co-extrusion process, the process simultaneously uses 2 different plastic materials such that a first material is used for the core material, which is encased in a different material used for the shell material. A rotating knife could cut extrusion to size as it exits the die. Alternately, in a coated injection molding process, a separate surface coating is applied to form the shell material over top of a second core material used to form the core prior to ejection from the mold.

While the imitation corn kernel 200 of the present disclosure has been described to be a corn kernel, it will be apparent to those skilled in the art that the invention described herein may be used with all types of grain, including wheat and soybean. As various changes could be made in the above constructions without departing from the broad scope of the invention, it is intended that all matter contained in the above description or shown in the accompanying drawings shall be interpreted as illustrative and not in a limiting sense.

1. An imitation corn kernel used to emulate a real corn kernel for use in research and testing of a grain drying system, the imitation corn kernel comprising a core material that retains moisture and a shell material that repels moisture.

2. The imitation corn kernel of claim 1 where the corn kernel has a general frusta-conical shape with a base end that is larger than a tip end.

3. The imitation corn kernel of claim 2 where the outer shell covers the entire base end.

4. The imitation corn kernel of claim 1 where the corn kernel the corn kernel has a cylindrical shape.

5. The imitation corn kernel of claim 1 where the corn kernel is made of a thermo plastic.

6. The imitation corn kernel of claim 1 where the corn kernel is made a zeolite.

7. The imitation corn kernel of claim 1 where the corn kernel has a length in the range from 0.46-0.54 inches, a width to range from 0.27-0.35 inches, and a thickness to range from 0.14-0.18 inches.
